(19) United States
(12) Patent Application Publication
(10) Pub. No.: US 2011/0273792 A1
(43) Pub. Date: Nov. 10, 2011

(54) Optical Designed Pattern and Structure Capable of Reflecting Light

(76) Inventors: Yuan-Hung Wang, Kuei-Shan Hsiang (TW); Cheng-Chung Kuan, Kuei-Shan Hsiang (TW)

(21) Appl. No.: 12/886,664

(22) Filed: Sep. 21, 2010

(30) Foreign Application Priority Data
May 10, 2010 (TW) 099114845

(51) Int. Cl. G02B 5/00

(52) U.S. Cl. 359/893

(57) ABSTRACT

An optical designed pattern is disclosed. The optical designed pattern comprises a plurality of screen dots; whereby a combination of a size of each screen dot, an arranging pitch of each screen dot, and a line width of each screen dot is provided to give the plurality of screen dots various optical characteristics to show all kinds of effects such as a hair pattern or a hair pattern with other composite patterns.

### BACKGROUND OF THE INVENTION

1. Field of the Invention

The present invention relates to an optical designed pattern and a structure capable of reflecting light, and more particularly, to an optical designed pattern comprising a plurality of screen dots and a structure capable of reflecting light.

2. Description of the Related Art

The texture decorations are widely applied in all kinds of products, such as the case of a mobile phone or the cover of a notebook computer. The texture on the surface of a product can provide visual, tactile, and functional effects. A metal texture can be achieved by directly processing a metal object or metalizing a plastic object, in which a hair pattern is often formed on the surface.

Traditionally, a master plate is mechanically processed in order to produce a hair pattern on an object. If the goal is to introduce a flatly hollow region in the hair pattern, the master plate is first processed to form the hair pattern on the entire surface, and then some of the hair pattern is removed to form the hollow region. However, the surface of the hollow region is not perfectly flat due to the mechanical processing; furthermore, it is even more difficult to form the hollow region if the hair pattern is too complicated or delicate. Besides, when using the master plate to reproduce the hair pattern on different objects, there is no guarantee that the reproduced hair patterns will remain the same for every object.

Therefore, it is necessary to provide an optical designed pattern and a structure capable of reflecting light to eliminate the deficiencies inherent in the prior art techniques.

### SUMMARY OF THE INVENTION

It is an object of the present invention to provide an optical designed pattern and a structure capable of reflecting light.

In order to achieve the above object, the present invention provides an optical designed pattern comprising: a plurality of screen dots, whereby a combination of a size of each screen dot, an arranging pitch of each screen dot, and a line width of each screen dot is provided to give the plurality of screen dots various optical characteristics.

In an embodiment of the present invention, the plurality of screen dots comprises at least one shape selected from a group consisting of a triangle, quadrangle, pentagon, hexagon, polygon, or any specified shape or their combination.

In an embodiment of the present invention, each screen dot substantially comprises a size of between 10 μm and 500 μm, and each dot comprises a plurality of end points, wherein the size of each screen dot is defined by the diameter of the largest circle comprising any two of the end points.

In an embodiment of the present invention, each screen dot comprises an arranging pitch substantially having a size of between 0 μm and 200 μm.

In an embodiment of the present invention, each screen dot comprises a line width substantially having a size of between 10 μm and 250 μm.

In order to achieve the above object, the present invention provides a structure capable of reflecting light comprising: a base material and an optical designed pattern disposed on the base material, wherein the optical designed pattern comprises: a plurality of screen dots, whereby a combination of a size of each screen dot, an arranging pitch of each screen dot, and a line width of each screen dot is provided to give the plurality of screen dots various optical characteristics.

In an embodiment of the present invention, the plurality of screen dots comprises at least one shape selected from a group consisting of a triangle, quadrangle, pentagon, hexagon, polygon, or any specified shape or their combination.

In an embodiment of the present invention, each screen dot substantially comprises a size of between 10 μm and 500 μm, and each dot comprises a plurality of end points, wherein the size of each screen dot is defined by the diameter of the largest circle comprising any two of the end points.

In an embodiment of the present invention, each screen dot comprises an arranging pitch substantially having a size of between 0 μm and 200 μm.

In an embodiment of the present invention, each screen dot comprises a line width substantially having a size of between 10 μm and 250 μm.

### BRIEF DESCRIPTION OF THE DRAWINGS

FIG. 1 illustrates a flowchart of a method for manufacturing a metal mold in an embodiment of the present invention;

FIG. 2 to FIG. 4 illustrate views for the method for manufacturing a metal mold in an embodiment of the present invention;

FIG. 5 illustrates an enlarged view of an optical designed pattern in an embodiment of the present invention;

FIG. 6 illustrates a further enlarged view of the optical designed pattern in an embodiment of the present invention;

FIG. 7A to FIG. 7C illustrate views of the shapes of the screen dots in an embodiment of the present invention;

FIG. 8 illustrates a view of the screen dots in an embodiment of the present invention;

FIG. 9A to FIG. 9C illustrate views of the screen dots in an embodiment of the present invention;

FIG. 10 to FIG. 14 illustrate views of the method for manufacturing a metal mold in an embodiment of the present invention;

FIG. 15 illustrates a view of a structure capable of reflecting light in an embodiment of the present invention; and

FIG. 16 illustrates an enlarged view of an optical designed pattern of the structure capable of reflecting light in an embodiment of the present invention.

### DETAILED DESCRIPTION OF THE PREFERRED EMBODIMENT

The advantages and innovative features of the invention will become more apparent from the following detailed description when taken in conjunction with the accompanying drawings.

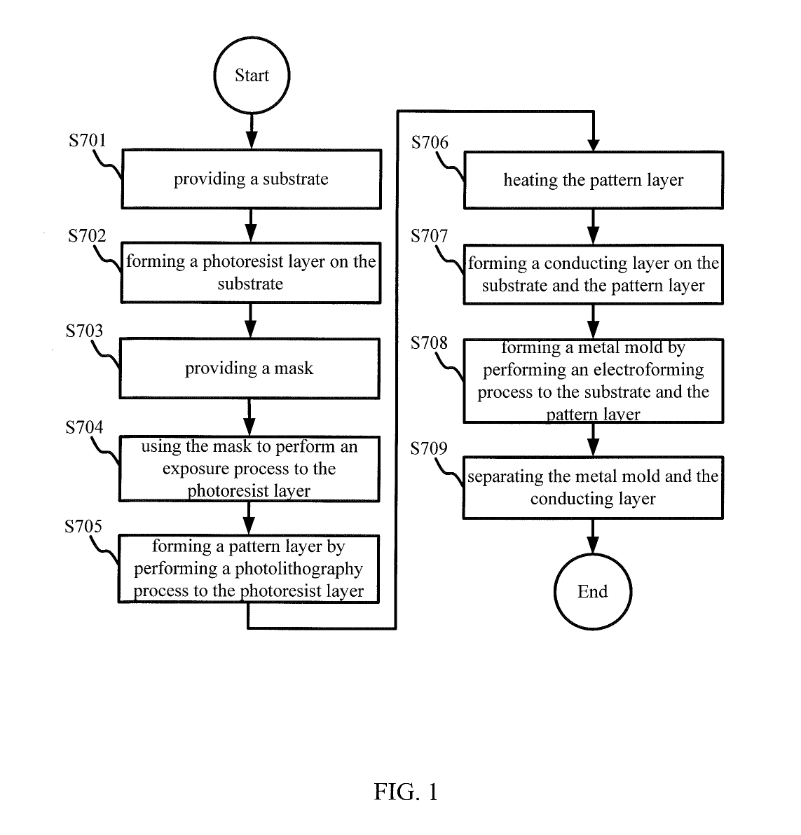

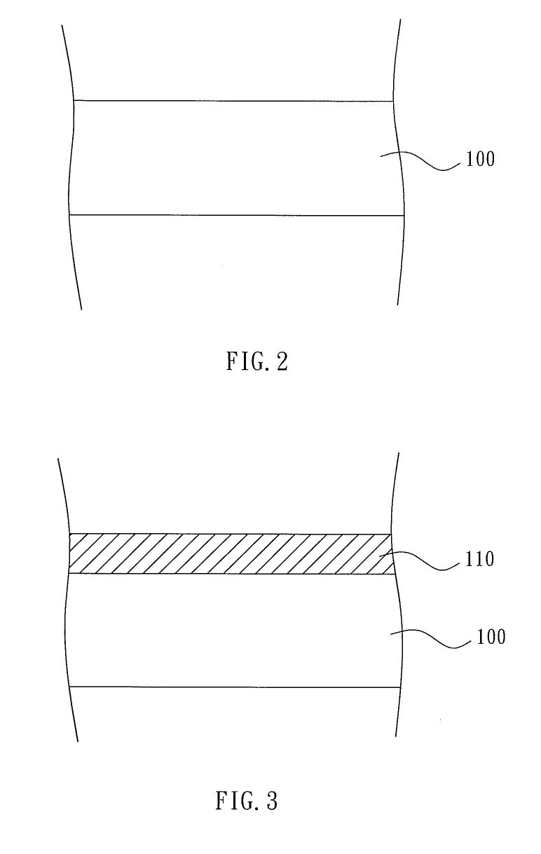

Please refer to FIG. 1 for a flowchart of a method for manufacturing a metal mold in an embodiment of the present invention, and also to FIG. 2 to FIG. 4 for views for the method for manufacturing a metal mold in an embodiment of the present invention, wherein the metal mold is used for processing the structure capable of reflecting light in the present invention.

As shown in FIG. 1, the present invention first proceeds to step S701: providing a substrate 100.

As shown in FIG. 2, in an embodiment of the present invention, the substrate 100 is made of glass or other suitable materials.

Then the process goes to step S702: forming a photoresist layer on the substrate.

As shown in FIG. 3, in an embodiment of the present invention, a photoresist layer 110 is formed on the substrate 100. The photoresist layer 110 is formed by using spin coating to coat the photoresist onto the surface of the substrate 100 and then by soft-baking the substrate 100 to remove the solvent in the photoresist so as to form the photoresist layer 110; however, the photoresist layer 110 can be formed by other methods. In an embodiment of the present invention, the photoresist can be a positive photoresist or a negative photoresist, and the photoresist layer 110 can be a positive photoresist layer or a negative photoresist layer. It is noted that the present invention is not limited to the use of any specific kind of photoresist.

Then the process goes to step S703: providing a mask.

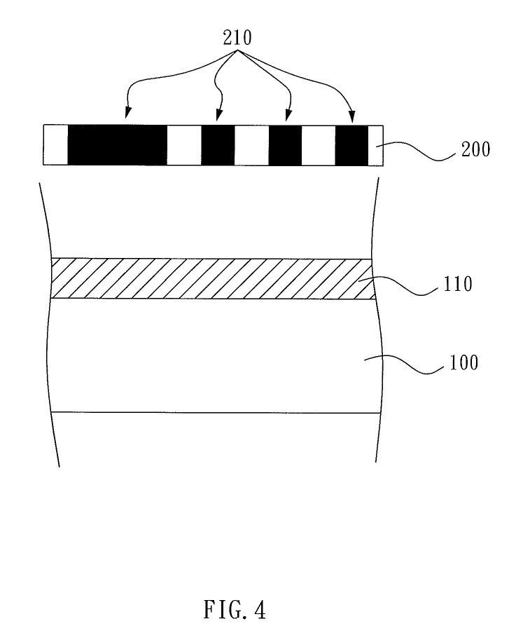

As shown in FIG. 4, in an embodiment of the present invention, the mask 200 comprises an optical designed pattern 210; when the photoresist layer 110 is a positive photoresist layer, the optical designed pattern 210 on the mask 200 is transmissive, and the other part of the mask is opaque; when the photoresist layer 110 is a negative photoresist layer, the optical designed pattern 210 on the mask 200 is opaque, and the other part of the mask is transmissive.

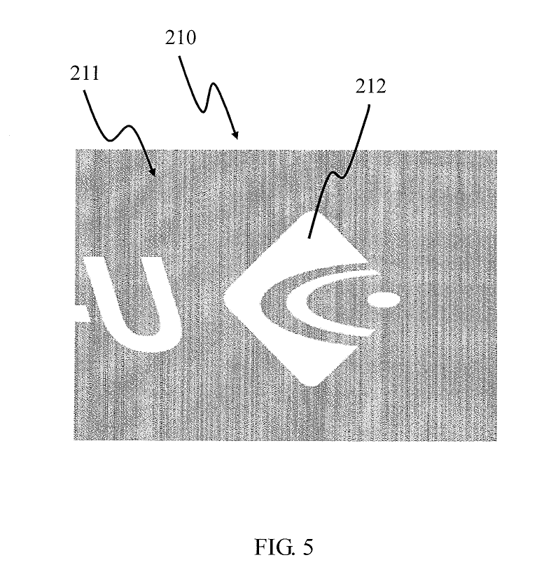

As shown in FIG. 5, which presents an enlarged view of the optical designed pattern 210 in an embodiment of the present invention, the optical designed pattern 210 comprises a plurality of screen dots 211 which are optically designed according to the requirements of the structure capable of reflecting light in the present invention, wherein the structure capable of reflecting light will be described in further detail below. In an embodiment of the present invention, the optical designed pattern 210 can provide visual effects such as a hair pattern or other pattern if necessary.

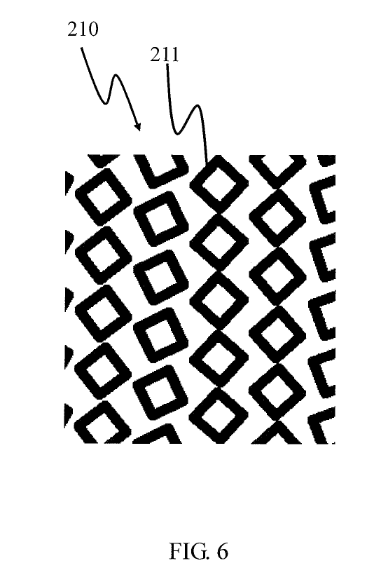

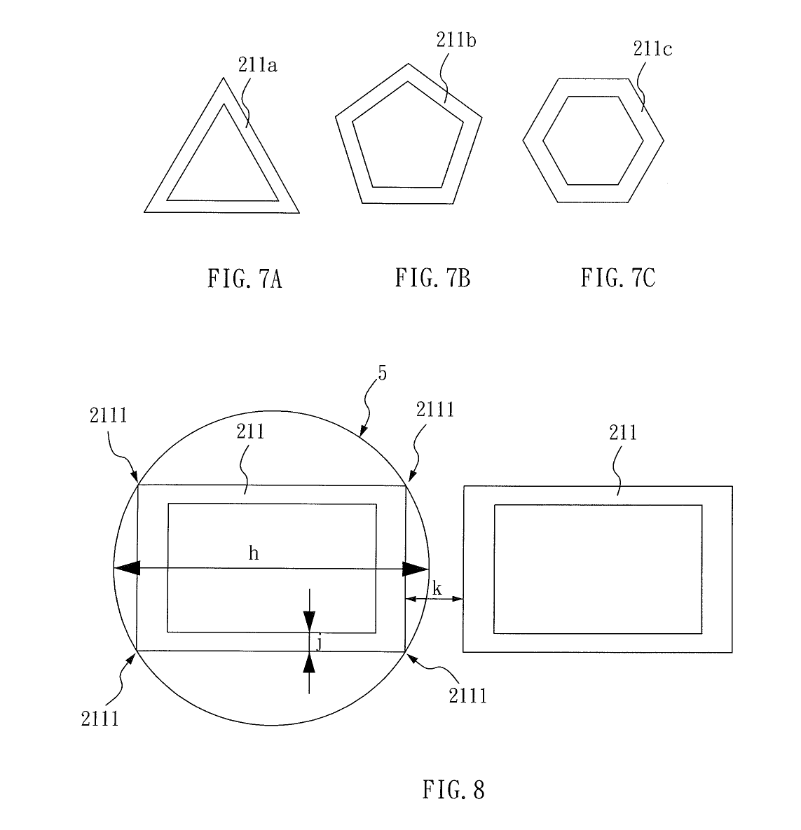

Please refer to FIG. 6 for a further enlarged view of the optical designed pattern in an embodiment of the present invention. As shown in FIG. 6, the optical designed pattern 210 comprises a plurality of screen dots 211; in an embodiment of the present invention, the plurality of screen dots 211 substantially comprises the shape of a quadrangle; however, the screen dots 211 can have other shapes. For example, the screen dots 211a, 211b, and 211c can comprise at least one shape selected from the group of a triangle (as shown in FIG. 7A), quadrangle and pentagon (as shown in FIG. 7B), hexagon (as shown in FIG. 7C), polygon, or any specified shapes. In the present invention, each specific shape allows the screen dots 211 to have different optical characteristics.

As shown in FIG. 8, in an embodiment of the present invention, each screen dot 211 substantially has a size h of between 10 μm and 500 μm, and each screen dot 211 includes a plurality of end points 2111; the size of each screen dot is defined by the diameter of the largest circle 5 comprising any two of the end points 2111; each screen dot 211 substantially has an arranging pitch k of between 0 μm and 200 μm; and each screen dot 211 substantially has a line width j of between 10μm and 250 μm; however, the present invention can have other implementations other than that described above. In addition, different arrangements and placements of the screen dots 211 can provide visual effects of different thicknesses; furthermore, the parameters of the screen dots, such as the shape, size, pitch, line width, rotation, breadth, and amplitude, are adjustable as well. For example, different angles of screen dots 211 in the arrangement can cause different patterns of reflection/refraction of light to form regions of different brightness and to provide oblique visual effects.

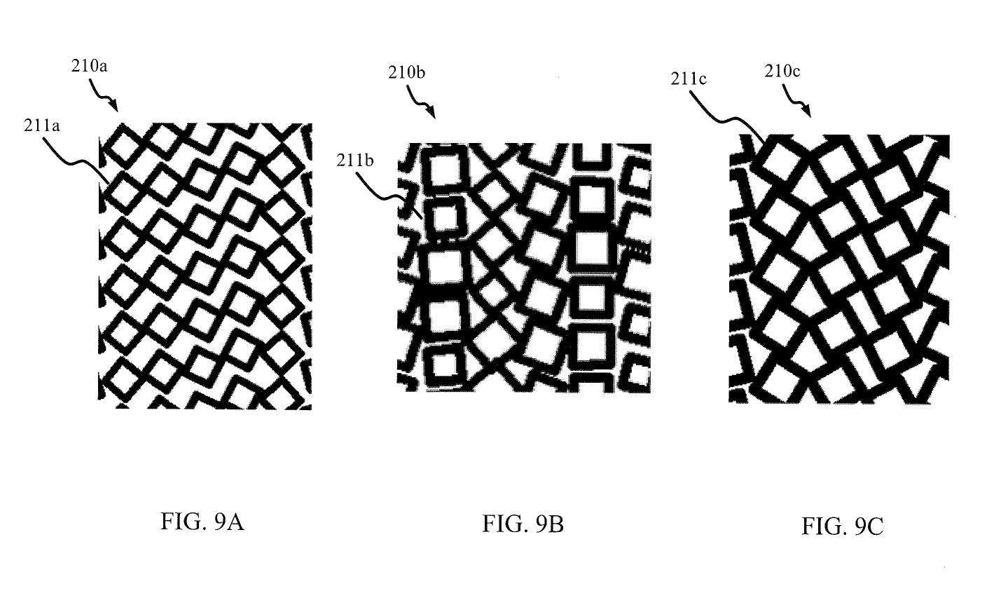

As shown in FIG. 9A, in an embodiment of the present invention, some of the screen dots 211 a in the optical designed pattern 210a are connected with each other, while some of the screen dots 211a are not; therefore, the arranging pitches between the screen dots 211 a are different. As shown in FIG. 9B, in an embodiment of the present invention, the size and line width of each screen dot 211b of the optical designed pattern 210b are different from others; in addition, the rotating angle and connecting point of each screen dot 211b differ from others as well. As shown in FIG. 9C, in an embodiment of the present invention, the rotating angle of each screen dot 211c of the optical designed pattern 210c is also different from others.

In an embodiment of the present invention, the structure can have some of its regions hollowed out by eliminating the corresponding screen dots 211 (please refer to the hollow region 212 in FIG. 5). If it is necessary to add other optical designed patterns or positioning marks, the user can add them to the mask in the layout stage to facilitate the freedom of design. It is noted that the technique of producing the mask is known in the art and will not be described for the sake of brevity.

Then the process goes to step S704: using the mask to perform an exposure process to the photoresist layer.

As shown in FIG. 4, in an embodiment of the present invention, the mask 200 is placed between the exposure machine (not shown in figure) and the substrate 100, wherein the exposure machine acts as a light source to project the optical designed pattern 210 onto the photoresist layer 110 through the mask 200.

Then the step goes to S705: forming a pattern layer by performing a photolithography process to the photoresist layer.

In the step S705, unnecessary regions of the photoresist layer 110 must be removed in order to reveal the pattern layer 111; when the photoresist layer 110 is a positive photoresist layer, the exposed region of the photoresist layer 110 is removed by the positive photoresist developer; when the photoresist layer 110 is a negative photoresist layer, the exposed region of the photoresist layer 110 is removed by the negative photoresist developer.

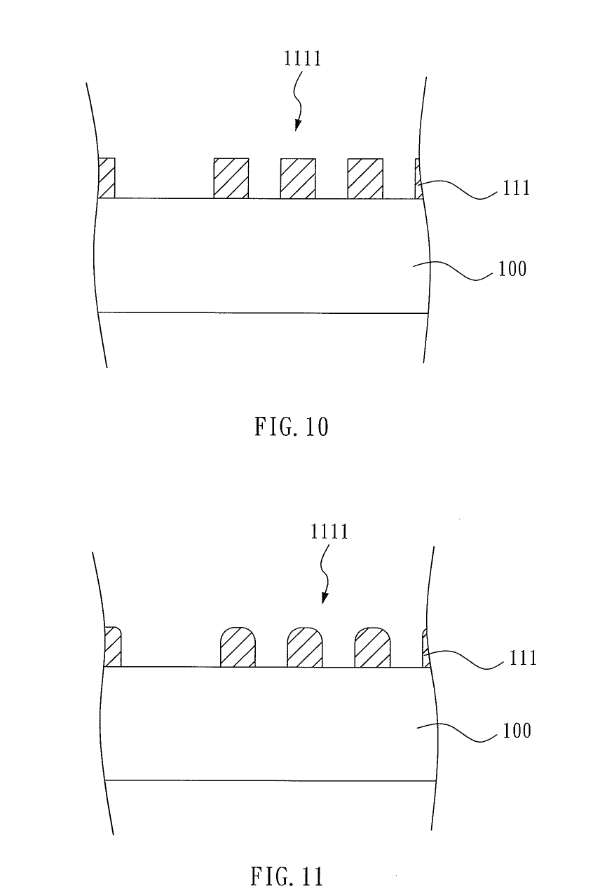

As shown in FIG. 10, in an embodiment of the present invention, the pattern layer 111 is formed after the photoresist layer 110 is exposed and developed, wherein the pattern layer 111 comprises a 3-dimensional structure corresponding to the screen dots 1111.

Then the process goes to step S706: heating the pattern layer.

As shown in FIG. 10, in an embodiment of the present invention, the 3-dimensional structure of screen dots 1111 of the developed pattern layer 111 is formed to have a rectangular shape. In step S706, it is possible to heat the pattern layer 111 to a temperature which is exactly or close to the glass transition temperature (Tg) of the pattern layer 111 to give the surface of the 3-dimensional structure of screen dots 1111 an arc shape (as shown in FIG. 11).

Then the process goes to step S707: forming a conducting layer on the substrate and the pattern layer.

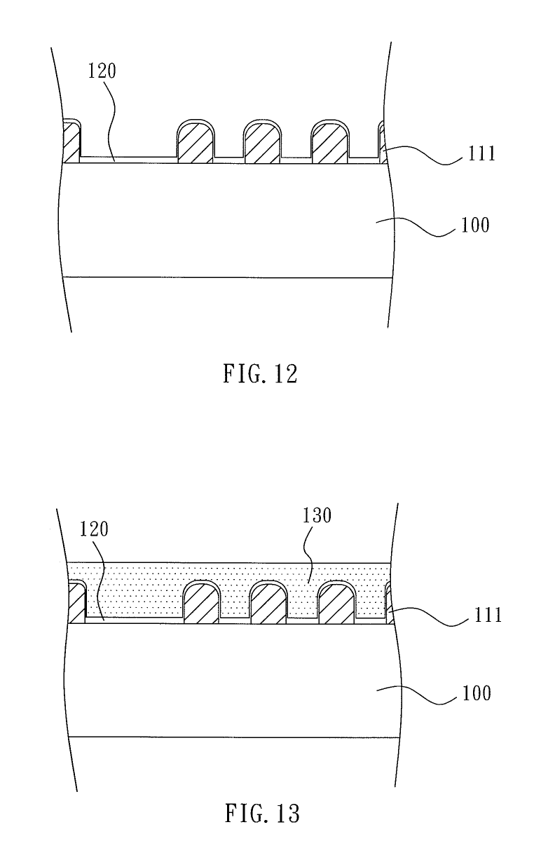

As shown in FIG. 12, in an embodiment of the present invention, a conducting layer 120 is formed on the substrate 100 and the pattern layer 111, wherein the conducting layer 120 can be a coating made of any metal (such as copper, copper alloy, silver, or silver alloy). In an embodiment of the present invention, the conducting layer substantially has a thickness of between 100 nm and 900 nm; however, the conducting layer can have a different thickness in the present invention.

Then the process goes to step S708: forming a metal mold by performing an electroforming process on the substrate and the pattern layer.

In an embodiment of the present invention, the substrate 100 is placed in an electroforming machine (not shown in figure) for the electroforming process. As shown in FIG. 13, the process uses the conducting layer 120 as a base layer and electrifies the conducting layer such that it acts as a starting layer and then deposits a metal mold 130 on the conducting layer 120. In an embodiment of the present invention, the metal mold 130 substantially has a thickness of between 50 μm and 800 μm; however, the metal mold 130 can have a different thickness in the present invention. In an embodiment of the present invention, the metal mold 130 can be made of a metal such as nickel, nickel alloy or other metals, and so on.

Finally the process goes to step S709: separating the metal mold and the conducting layer.

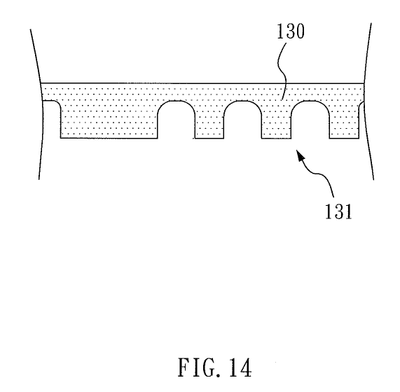

As shown in FIG. 14, in an embodiment of the present invention, the surface of the metal mold 130 comprises a first 3-dimensional pattern layer 131; the first 3-dimensional pattern layer 131 is formed in accordance with the 3-dimensional structure of screen dots 1111.

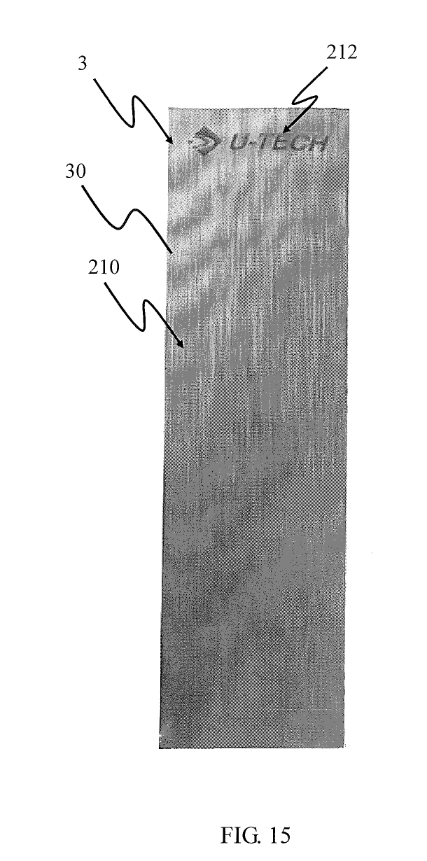

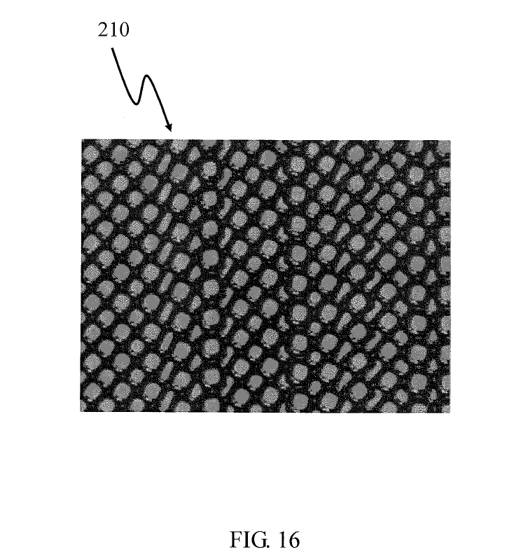

Please now refer to FIG. 15 and FIG. 16 for views of the structure capable of reflecting light in an embodiment of the present invention.

As shown in FIG. 15, the structure 3 capable of reflecting light comprises a base material 30 and an optical designed pattern 210, wherein the optical designed pattern 210 is on the base material 30. In an embodiment of the present invention, the optical designed pattern 210 is formed by using the metal mold 130 (as shown in FIG. 14) resulting from the above steps of processing the base material 30. In an embodiment of the present invention, the optical designed pattern 210 substantially comprises a hair pattern, and the optical designed pattern 210 also substantially comprises a hollow region 212; however, the optical designed pattern 210 can comprise other patterns. It is noted that in the step of forming the metal mold, the substrate is made of glass; therefore, when the hollow region implemented by the metal mold is formed, the hollow region can have a mirror-like surface.

In an embodiment of the present invention, the metal mold 130 is used for forming the structure 3 capable of reflecting light by using a method such as a hot press process, an injection molding process, a roll gluing process, or a casting process, or another suitable method. In an embodiment of the present invention, the structure 3 capable of reflecting light is made of plastic or metal, or other suitable materials.

Please refer to FIG. 16, which illustrates an enlarged view of the optical designed pattern 210 of the structure 3 capable of reflecting light in FIG. 15 of the present invention. When a light source irradiates light onto the optical designed pattern 210 of the structure 3, the optical designed pattern 210 can reflect the light to show at least one optical effect, and the optical designed pattern 210 can also exhibit various effects in accordance with different reflections and angle variations.

Hence, the present invention provides a method for producing a metal mold and a structure formed by using the metal mold; therefore, the present invention is advantageous in the following ways: 1. The present invention uses optical design to form all kinds of optical designed patterns or hollow effects with only one mask, while in the prior art, it is necessary to use a plurality of mechanical processes to form a structure having both an optical designed pattern and a hollow region; 2. The present invention uses glass to build the substrate, so when the hollow region implemented by the metal mold is formed, the hollow region can have a mirror-like surface.

It is noted that the above-mentioned embodiments are only for illustration. It is intended that the present invention cover modifications and variations of this invention provided they fall within the scope of the following claims and their equivalents. Therefore, it will be apparent to those skilled in the art that various modifications and variations can be made to the structure of the present invention without departing from the scope or spirit of the invention.

What is claimed is:

1. An optical designed pattern comprising:
a plurality of screen dots, whereby a combination of a size of each screen dot, an arranging pitch of each screen dot, and a line width of each screen dot is provided to give the plurality of screen dots various optical characteristics.

2. The optical designed pattern as claimed in claim 1, wherein the plurality of screen dots comprises at least one shape selected from the group consisting of a triangle, quadrangle, pentagon, hexagon, polygon, or any specified shape or combination thereof.

3. The optical designed pattern as claimed in claim 1, wherein each screen dot substantially comprises a size of between 10 μm and 500 μm, and each dot comprises a plurality of end points, wherein the size of each screen dot is defined by a diameter of the largest circle comprising any two of the end points.

4. The optical designed pattern as claimed in claim 1, wherein each screen dot comprises an arranging pitch substantially having a size of between 0 μm and 200 μm so as to provide visual effects of different thicknesses through arranging pitches of different sizes.

5. The optical designed pattern as claimed in claim 1, wherein each screen dot comprises a line width substantially having a size of between 10 μm and 250 μm so as to provide visual effects of different thicknesses through arranging line widths of different sizes.

6. The optical designed pattern as claimed in claim 1, wherein the optical designed pattern comprises a hair pattern or a hair pattern with a partly hollow region.

7. The optical designed pattern as claimed in claim 6, wherein the hair pattern and the hollow region are formed simultaneously.

8. A structure capable of reflecting light comprising:
a base material; and
an optical designed pattern disposed on the base material, wherein the optical designed pattern comprises:
a plurality of screen dots, whereby a combination of a size of each screen dot,
an arranging pitch of each screen dot, and a line width of each screen dot are provided to give the plurality of screen dots various optical characteristics.

9. The structure capable of reflecting light as claimed in claim 8, wherein the plurality of screen dots comprises at least one shape selected from the group consisting of a triangle, quadrangle, pentagon, hexagon, polygon, or any specified shape or combination thereof.

10. The structure capable of reflecting light as claimed in claim 8, wherein each screen dot substantially comprises a size of between 10 μm and 500 μm, and each dot comprises a plurality of end points, wherein the size of each screen dot is defined by the diameter of the largest circle comprising any two of the end points.

11. The structure capable of reflecting light as claimed in claim 8, wherein each screen dot comprises an arranging pitch substantially having a size of between 0 μm and 200 μm so as to provide visual effects of different thicknesses through arranging pitches of different sizes.

12. The structure capable of reflecting light as claimed in claim 8, wherein each screen dot comprises a line width substantially having a size of between 10 μm and 250 μm so as to provide visual effects of different thicknesses through arranging line widths of different sizes.

13. The structure capable of reflecting light as claimed in claim 8, wherein the base material is made of plastic or metal.

14. The structure capable of reflecting light as claimed in claim 8, wherein the optical designed pattern comprises a hair pattern or a hair pattern with a partly hollow region.

15. The structure capable of reflecting light as claimed in claim 14, wherein the hair pattern and the hollow region are formed simultaneously.
